(19) United States
(12) Patent Application Publication
(10) Pub. No.: US 2026/0066689 A1
(43) Pub. Date: Mar. 5, 2026

(54) STRATEGIC RESILIENT GENERATION OF CLEAN ELECTRIC POWER

(71) Applicant: EV ANYTIME LLC, Thorndike, MA (US)

(72) Inventors: RONALD L. JOHNSON, Boylston, MA (US); William D.B. Fay, Ware, MA (US); Celeste N. Fay, Boylston, MA (US)

(21) Appl. No.: 19/072,825

(22) Filed: Mar. 6, 2025

Related U.S. Application Data
(60) Provisional application No. 63/563,227, filed on Mar. 8, 2024.

(51) Int. Cl. H02J 9/06; H02J 7/00

(52) U.S. Cl. CPC H02J 9/06; H02J 7/50

(57) ABSTRACT

A strategic resilient synchronous generation system and a method of generating clean electric power is provided without the need for inverters. The method includes identifying an acceptable hydropower project that is capable of anchoring a microgrid of the present invention. The system includes a hydropower generator that is capable of providing stable, synchronous power to the microgrid. The microgrid includes various features to protect the system from cyber attacks, physical attacks, and electromagnetic pulses. The microgrid is configured to not require external fuel sources. The microgrid is configured to provide a continuous source of electricity from carbon free sources and is also configured to be blackstart capable. The microgrid is configured to selectively attach or detach from other electrical grids, such as other microgrids and/or primary electric grids of a region. The microgrid includes power generation capabilities, power storage capabilities, and power transfer capabilities. The power transfer capabilities include charging stations for electrical vehicles and other electrically dependent devices.

### CROSS-REFERENCE TO RELATED APPLICATIONS

This application claims priority pursuant to 35 U.S.C. 119(e) to U.S. Provisional Patent Application Ser. No. 63/563,227, filed Mar. 8, 2024, the entire disclosure of which is incorporated herein by reference.

### FIELD OF THE INVENTION

The present invention relates generally to resilient generation of clean electric power. More specifically, the present invention is concerned with strategic electric microgrids based on hydroelectric power generation that are indefinitely capable of powering key resources, such as electric vehicles and communications without external fuel sources.

### BACKGROUND

The ongoing electrification of various industries, such as transportation, continues to increase the burden on the existing electric grid (the “Primary Grid”). For instance, as the number of electrical vehicles continues to increase, the charging requirements for such vehicles also increases. Unfortunately, upgrading the Primary Grid is time consuming and expensive, making it difficult for the Primary Grid's power capabilities to keep pace with the ever-increasing power requirements. Accordingly, it would be advantageous to have a power generation system that is capable of sensing the quality and demand of grid power and balancing the required power quality and import or export of energy within the system capabilities.

The ongoing electrification of vehicles includes local emergency vehicles, with many states mandating electrification of vehicular fleets. While this transition decreases risks associated with reliance on traditional fossil-fuel fleets, it introduces risks associated with increased reliance on the Primary Grid. For instance, many emergency situations include at least some interruption in power transfer through the Primary Grid, and some emergency situations include an interruption in power supply to the Primary Grid. Prolonged or untimely interruptions in available power from the Primary Grid can severely hinder emergency response capabilities for an electrified fleet. Accordingly, it would be advantageous to have a resilient power source for powering electrified emergency vehicles during an emergency situation.

The US Military is also transitioning to electrified vehicles, thereby increasing the importance of having reliable electric power supply, and possibly increasing the chances of the Primary Grid being the target of a military or terrorist attack. Accordingly, it would be beneficial to have strategic power supply that is resilient, can continuously supply power, and not easily susceptible to military or terrorist attacks.

The massive size of the Primary Grid makes it difficult to protect from various attacks, such as physical attacks, cyber attacks, and electromagnetic pulses attacks. For instance, the Primary Grid consists of large areas of transmission lines, distribution lines, generation sources, and end users. A single power outage can affect millions or tens of millions of people as the Primary Grid consists of large interconnected systems. The Primary Grid is vulnerable to physical, cyber and EMP attack and a single attack can take out a large portion of the system. Accordingly, it would be beneficial to have a secure power supply that is less susceptible than the Primary Grid to various potential attacks.

The desire for long term security is part of the push to move away from fossil fuels, which have a limited supply and cause pollution. Unfortunately, to date, renewable energy has failed to completely supplant fossil fuels as a reliable power source. As a result, even when consumers are paying a premium for carbon-free power, it is difficult or impossible for existing power grids to provide a “green” power supply. Instead, a “brown mix” is usually the best existing reliable power grids have been able to provide. Accordingly, it would be beneficial to have a reliable microgrid that is capable of providing 100% green power.

Existing microgrids tend to disconnect from the Primary Grid when there is a power outage or a power shortage. While potentially advantageous for those connected to the microgrid, the benefits to the Primary Grid can be limited (for power shortages) or non-existent (for power outages). Accordingly, it would be beneficial to have a microgrid that is capable of connecting to the Primary Grid during a power outage or a power shortage, thereby helping to balance power requirements for those on the Primary Grid or helping to restart the Primary Grid if completely down.

Microgrids are not a new concept and are known to exist at hospitals and other key demand locations today. However, they are typically powered by fossil fuels because current carbon free generation microgrids struggle with technical issues associated with frequency control, power factor correction, and black start (known collectively as “stable power”). Accordingly, it would be beneficial to have a 100% carbon free generation microgrid that is capable of providing stable power, continuous power, and be capable of blackstart generation.

Solar and wind do not provide stable power, and therefore are typically paired with power storage devices, such as batteries. Unfortunately, batteries require a charge, making it impossible to black start some microgrids unless there is sufficient availability of wind, solar, or battery charge, the availability of each being sporadic and somewhat unpredictable. Accordingly, it would be beneficial to have a microgrid that is powered by a steady, predictable power source even when blackstart operation is required.

Some microgrids, such as hospital microgrids, are required by federal law to have a power back-up system that is capable of providing 96 hours of power supply, independent of the Primary Grid. Purchasing and maintaining the necessary equipment (such as generators and/or battery packs) to meet this requirement can be expensive, which can be difficult to justify if the back-up system is never needed. Typically the back-up generators are supplied by fossil fuels and a supply of fuel to maintain the 96 hours is stored on or around the facility. And if the back-up system is needed, 96 hours of fuel supply may not be enough to satisfy the power requirements. Accordingly, it would be beneficial to have a resilient power back-up system that does not require the expensive equipment, maintenance costs, and required fueling of traditional back-up systems and can operate indefinitely without an offsite supply of fuel. It would be further advantageous if the back-up system was capable of providing uninterrupted power generation for as long as the back-up power system is required.

### SUMMARY

The present invention comprises a power generation system that is capable of connecting to the power grid during normal operations and operating independently of the power grid during a power grid outage.

The present invention comprises a resilient power supply system that is capable of charging emergency vehicles or power any other device during interruptions in power transfer through the Primary Grid or power supply to the Primary Grid.

The present invention comprises a strategic power supply that is resilient and not easily susceptible to military or terrorist attacks.

The present invention comprises a reliable microgrid that is capable of providing 100% green power.

The present invention comprises a system capable of supporting grid services such as frequency control during normal operations.

The present invention comprises a 100% carbon free generation microgrid that is capable of providing stable power without inverters.

The present invention comprises a synchronous power microgrid that includes a carbon free power generation source capable of black start, frequency control, power factor adjustment, and continuous operation without requiring offsite fuel.

The present invention comprises a resilient power source that can microgird and provide synchronous power without inverters.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

A preferred embodiment of the invention, illustrative of the best mode in which the applicant has contemplated applying the principles, is set forth in the following description and is shown in the drawings and is particularly and distinctly pointed out and set forth in the appended claims.

FIG. 1 is high-level schematic of a system of the present invention.

FIG. 2 is a high-level schematic of a system of the present invention.

FIG. 3 is an image of an existing dam that could be utilized by a system of the present invention.

FIG. 4 is an image of an existing dam that could be utilized by a system of the present invention.

FIG. 5 is an image of an EV charging station that could be utilized by a system of the present invention.

FIG. 6 is a map of the United States, the image including markings to indicate potential locations for hydropower generation associated with a system of the present invention.

Appendix A is a handout describing certain features of the present invention.

Appendix B is a presentation associated with the present invention.

Appendix C is a write-up associated with the present invention.

### DETAILED DESCRIPTION

As required, a detailed embodiment of the present invention is disclosed herein; however, it is to be understood that the disclosed embodiment is merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

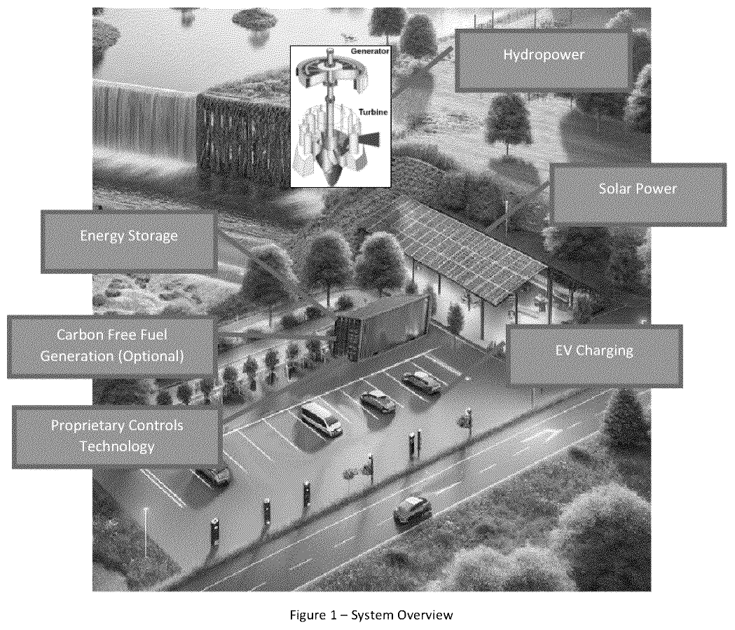

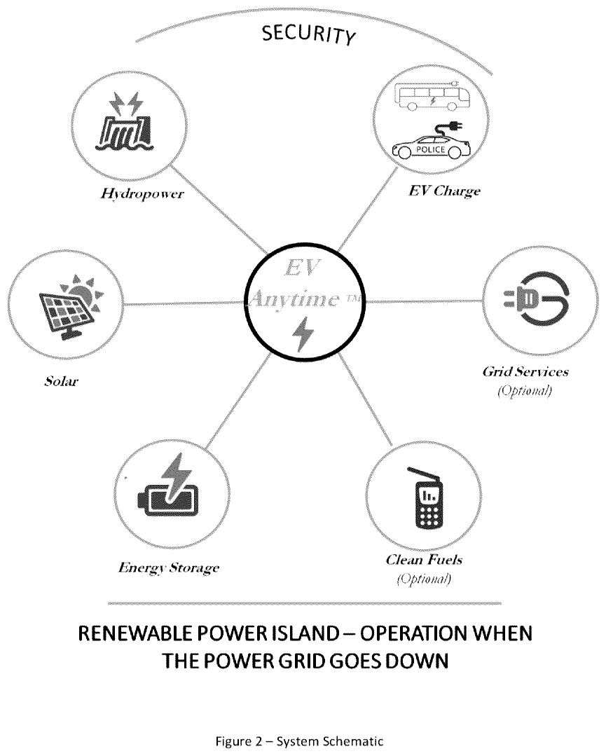

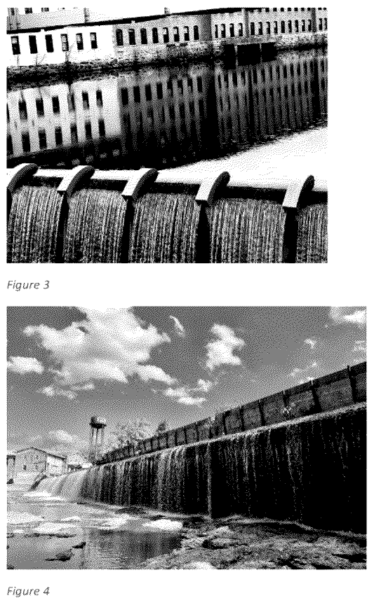

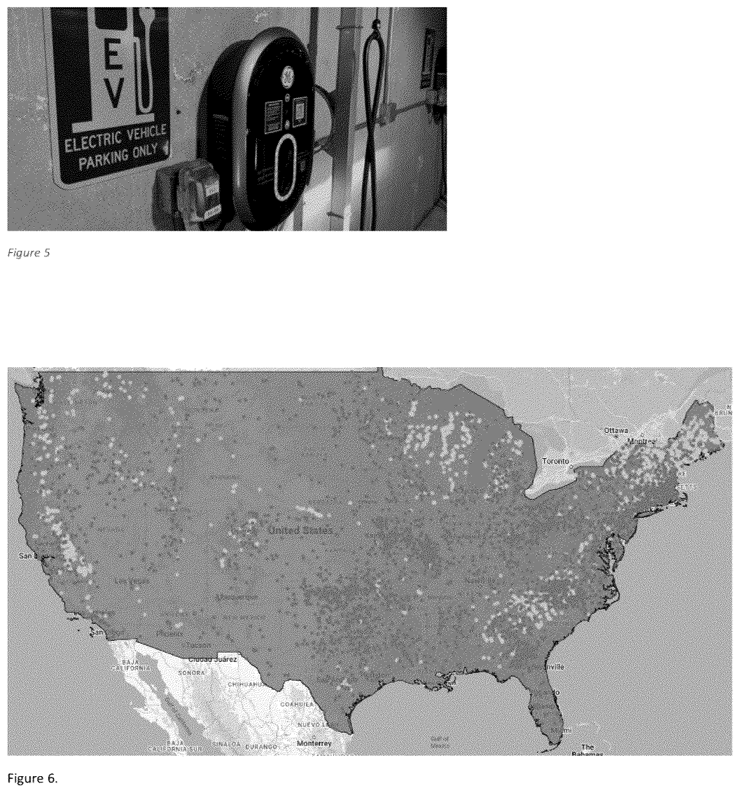

Referring to FIGS. 1 and 2, the present invention provides secure renewable electricity for charging electrical vehicles and for satisfying other key emergency response electricity demands such as communications. In some embodiments, the system is designed to be a microgrid that is capable of continuing to generate carbon free synchronous electricity and provide charging even when there is an outage, or other issues, with the Primary Grid without the need for complex AC/DC inverters or stored energy. In some embodiments, when compared with the Primary Grid and existing microgrids, the microgrid of the present invention includes enhanced cyber security, improved EMP vulnerability resistance, and robust physical security.

In some embodiments, power generation for a system of the present invention is 100% from renewable energy sources. Renewable energy means that sources of generation exclude fossil fuels. In some embodiments, the foundation is hydropower with additional renewable sources, such as solar and wind and carbon-free attributes, complimenting the hydropower.

In some embodiments, the system is specifically designed to address the ongoing electrification of various industries, such as transportation. In some embodiments, the system is specifically designed to address a serious vulnerability to the United States if the Primary Grid has an outage. In some embodiments, the system is specifically designed to provide alternative carbon-free back up sources, the alternative source of the present invention not having the very limited duration capabilities and other limitations associated with existing carbon-free backup sources which rely on energy storage and inverter technology to provide synchronous power. In some embodiments, the present invention is configured to reduce or eliminate the need for fossil fuels, such as fossil fuels that currently are utilized for most transportation and back-up generators. In some embodiments, the present invention is configured to facilitate transitions to electrified vehicle fleets, thereby helping to meet mandates in place for the US Military and various States'vehicular fleets (including emergency response such as police vehicles). For instance, in some embodiments the present invention is configured to negate risks associated with prolonged outages of the Primary Grid by providing sufficient infrastructure to ensure that emergency vehicles can be charged in a timely manner.

In some embodiments, the present invention includes identifying a small hydropower project that is capable of being a primary power source for a microgrid of the present invention. In some embodiments, the present invention includes identifying locations for the development of new hydropower projects that are capable of being a primary power source for a microgrid of the present invention. In some embodiments, the present invention comprises installing new generation or upgrading a power generator for the hydropower project. In some embodiments, the present invention comprises paring the hydropower generator with an energy storage mechanism, such as batteries, clean fuel generation, or the like, thereby facilitating capture of excess energy for later use. In some embodiments, the present invention comprises identifying potentially feasible additional renewable energy sources, such as solar generation, and configuring the system to utilize the same to supplement the hydropower generation. In some embodiments, a microgrid of the present invention is configured to be interconnected to the Primary Grid during normal operations. In some such embodiments, the microgrid is configured to operate as an independent microgrid during an outage or other power interruption of the Primary Grid. In some such embodiments, the system includes a mechanism for detecting and determining when to disconnect the microgrid from the Primary Grid and/or when to reconnect the microgrid to the Primary Grid. In some embodiments, the system includes a mechanism for disconnecting the microgrid from the Primary Grid. In some embodiments, the system includes a mechanism for connecting the microgrid to the Primary Grid. In some embodiments, the microgrid of the present invention is configured to operate completely independent of the Primary Grid such that the microgrid of the present invention has the capability to operate as a microgrid under all conditions. Regardless of interconnection type, the ability of the microgrid of the present invention to operate autonomous of the Primary Grid means that electricity will be available for various emergency response charging needs. Some embodiments of system will be capable of providing grid benefits such as black start, frequency control and power factor adjustment in some situations when interconnected.

In some embodiments, a microgrid of the present invention is a small network of generation sources thereby providing onsite, behind the meter electric vehicle and other similar uses. In some embodiments, the microgrid has the capability to interact with the Primary Grid (although it doesn't have to). But it must have the ability to operate independently from the main electric grid in island mode. The ability to island is very attractive to critical operations such as first responders, military operations, hospitals, airports, and water treatment facilities as they provide a level of resilience, redundancy and independence from the Primary Grid.

Some microgrids of the present invention address technical issues with frequency control, power factor correction, and black start. For instance, hydropower is one of the only types of carbon free power generation that can provide all the technical characteristics of synchronous power generation (typically seen with fossil fuels) that can support an electric grid with features such as frequency control, power factor correction, and black start capabilities. This is also known as stable power or firm power generating source. Accordingly, the microgrids of the present invention are configured to provide stable synchronous power without inverters. In some embodiments, an inverted source of carbon free generation may supplement the synchronous power of the system.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the description and illustration of the inventions is by way of example, and the scope of the inventions is not limited to the exact details shown or described.

Although the foregoing detailed description of the present invention has been described by reference to an exemplary embodiment, and the best mode contemplated for carrying out the present invention has been shown and described, it will be understood that certain changes, modification or variations may be made in embodying the above invention, and in the construction thereof, other than those specifically set forth herein, may be achieved by those skilled in the art without departing from the spirit and scope of the invention, and that such changes, modification or variations are to be considered as being within the overall scope of the present invention. Therefore, it is contemplated to cover the present invention and any and all changes, modifications, variations, or equivalents that fall within the true spirit and scope of the underlying principles disclosed and claimed herein. Consequently, the scope of the present invention is intended to be limited only by the attached claims, all matter contained in the above description and shown in the accompanying drawings shall be interpreted as illustrative and not in a limiting sense.

Having now described the features, discoveries and principles of the invention, the manner in which the invention is constructed and used, the characteristics of the construction, and advantageous, new and useful results obtained; the new and useful structures, devices, elements, arrangements, parts and combinations, are set forth in the appended claims.

It is also to be understood that the following claims are intended to cover all of the generic and specific features of the invention herein described, and all statements of the scope of the invention which, as a matter of language, might be said to fall therebetween.

1. A resilient power supply system that is capable of charging emergency vehicles, the power supply system comprising:
a strategic power source that is resilient and not easily susceptible to military or terrorist attacks; and
a microgrid in electrical communication with the strategic power source,
wherein the microgrid is independent of a primary grid.

2. The system of claim 1, wherein the strategic power source is a carbon-free power generation source that is capable of black start, frequency control, power factor adjustment, and continuous operation without requiring offsite fuel.

3. The system of claim 2, wherein the system does not require power inverters.

4. The system of claim 1, wherein the system does not require power inverters.

5. A network of independent resilient power supply systems, each of which is capable of charging emergency vehicles, the network comprising:
a plurality of strategic power sources, each strategic power source being resilient and not easily susceptible to military or terrorist attacks; and
a plurality of microgrids, each microgrid being in electrical communication with a respective strategic power source,
wherein each microgrid is independent of a primary grid and each of the other microgrids of the plurality of microgrids.

6. The network of claim 5, wherein each strategic power source is a carbon-free power generation source that is capable of black start, frequency control, power factor adjustment, and continuous operation without requiring offsite fuel.

7. The network of claim 6, wherein each system does not require power inverters.

8. The network of claim 1, wherein each system does not require power inverters.
